(19) United States
(12) Patent Application Publication
(10) Pub. No.: US 2022/0180169 A1
(43) Pub. Date: Jun. 9, 2022

(54) Family Scoring system using Artificial Intelligence in Real Estate Transactions

(71) Applicants: Narendra Ramchandra Gore, Cumming, GA (US); Ranjit Jagirdar Sham, Johns Creek, GA (US)

(72) Inventors: Narendra Ramchandra Gore, Cumming, GA (US); Ranjit Jagirdar Sham, Johns Creek, GA (US)

(21) Appl. No.: 17/111,295

(22) Filed: Dec. 3, 2020

(51) Int. Cl. G06N 3/08; G06N 3/04; G06Q 30/02; G06Q 50/00; G06Q 50/16; G06K 9/62; G06K 9/00

(52) U.S. Cl. CPC G06N 3/08; G06N 3/04; G06Q 30/0205; G06K 9/00624; G06Q 50/16; G06K 9/6217; G06Q 50/01

(57) ABSTRACT

Familial considerations are a key component in making decisions related to buying and selling of real estate such as primary residences. In this system these considerations are represented using the definition of a family score based on criteria which range from the needs of self, spouse partner, parents, children, other family and friends.

We recommend using a deep learning and machine learning-based approach to determine the family score. The family score is the weighted score determined by the current and evolving needs of family and events which determine property transaction decisions. The system will determine the family score for each property in-order to provide the suitability of the property for a given family. The considerations for mapping properties and families will depend on the attributes of the property and the requirements of the family.

Familial considerations are a key component in making decisions related to buying and selling of real estate such as primary residences. In this system these considerations are represented using the definition of a family score based on criteria which range from the needs of self, spouse/partner, parents, children, other family and friends.

We recommend using a deep learning and machine learning-based approach to determine the family score. The family score is the weighted score determined by the current and evolving needs of family and events which determine property transaction decisions. The system will determine the family score for each property in-order to provide the suitability of the property for a given family. The considerations for mapping properties and families will depend on the attributes of the property and the requirements of the family.

The embodiment considers multiple attributes of family members and uses artificial intelligence to determine what property type is best suitable for the family. Attributes such as employment opportunity, workplace commute, children healthcare needs, children/seniors special care needs are critical components of the family score and vary from family to family. Further the embodiment takes into consideration family events such as marriage, divorce, birth/death, retirement, job loss and future education needs. The family score will also consider overall sentiment of the family. Trends in crime rate, growth rate and socio economic status of the identified location based on the family attributes are also included. Pictures of the property, geo spatial data are analyzed using deep learning to map the familial needs with the property attributes.

The system leverages Artificial intelligence to provide correlation between the property attributes and family needs in-order to derive family score. A high family score indicates fitment of the property to the family. The system may be used for identifying relocation areas, property types and suitable property based on the family score.

### DRAWINGS—FIGURES

FIG. 100 shows AI Based Family Scoring Functional Architecture.

FIG. 150 shows architecture for Family scoring engine

FIG. 200 shows model for creating Family Score

FIG. 300 shows Family Structure applied for Scoring

FIG. 400 shows Family Assessment attributes

FIG. 500 shows Family needs assessment for parents, kids and in-laws,

FIG. 600 shows analysis of various events associated with Family

FIG. 700 shows Detailed technical architecture for calculating Family score

### REFERENCE NUMERALS

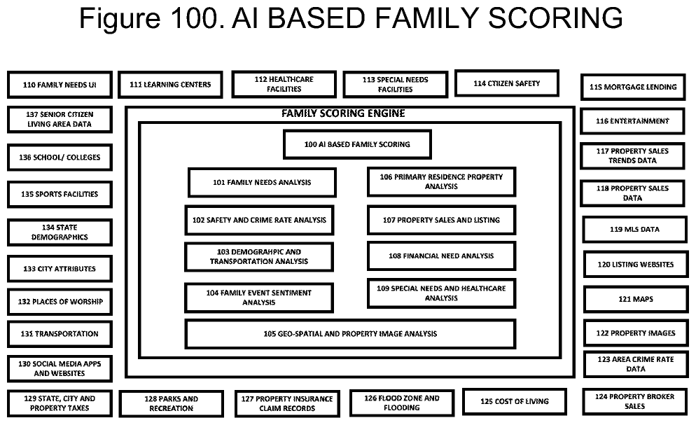

Following are the reference numerals for FIG. 100

101 Family needs analysis

102 Safety and crime rate analysis

103 Demographic and transportation analysis

104 Family event sentiment analysis

105 Geo-spatial and property image analysis

106 Primary residence property analysis

107 Property sales and listings analysis

108 Financial needs analysis

109 Special needs and healthcare analysis

110 Family Needs UI

111 Learning Centers

112 Healthcare facilities

113 Special-needs facilities

114 Citizen safety

115 Mortgage lending

116 Entertainment

117 Property sales trends data

118 Property Sales data

119 MLS Data

120 Listing websites

121 Maps

122 Property images

123 Area crime rate

124 Property broker sales

125 Cost of living

126 Flood zone and flooding

127 Property insurance claim records

128 Parks and recreation

129 State, City and Property taxes

130 Social Media Apps and Websites

131 Transportation

132 Places of Worship

133 City Attributes

134 State demographics

135 Sports facilities

136 School/colleges

137 Senior citizen living area data

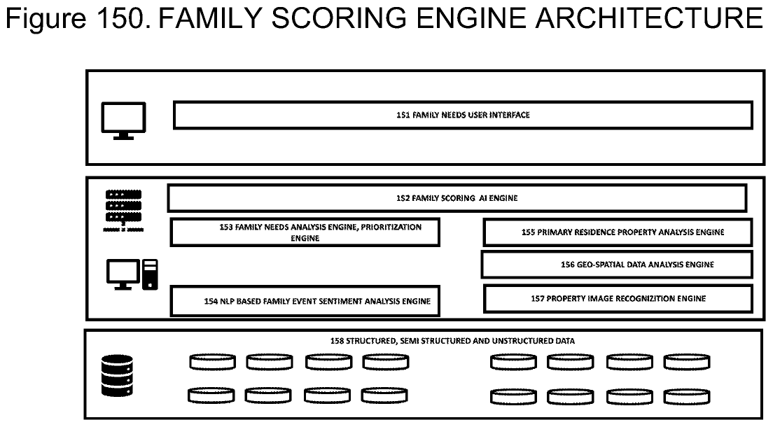

Following are the reference numerals for FIG. 150

151 Family Needs User Interface

152 Family Scoring AI Engine

153 Family Needs Analysis Engine, Prioritization Engine

154 NLP based Family Event Sentiment Analysis Engine

155 Primary Residence Property Analysis Engine

156 Geo-Spatial Data Analysis Engine

157 Property Image Recognition Engine

158 Structured, Semi Structured and Unstructured Data

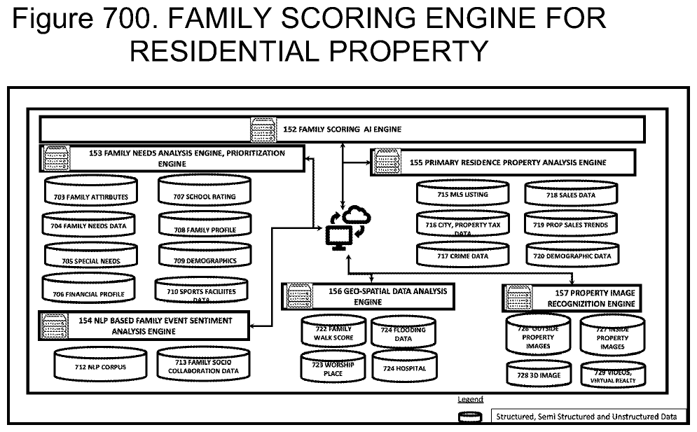

Following are the reference numerals for FIG. 700

703 Family Attributes

704 Family Needs Data

705 Special Needs

707 School Rating

708 Family Profile

709 Demographics

710 Sports Facilities Data

712 NLP Corpus

713 Family Socio Collaboration Data

715 MLS Listing

716 City, Property Tax Data

717 Crime Data

718 Sales Data

719 Prop Sales Trends

720 Demographic Data

722 Family Walk Score

723 Worship Place

724 Flooding Data

724 Hospital

726 Outside Property Images

727 Inside Property Images

728 3D Image

729 Videos, Virtual Realty

### DETAILED DESCRIPTION OF THE INVENTION

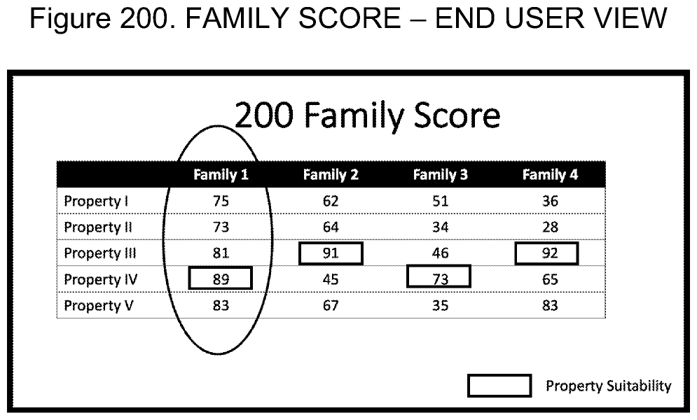

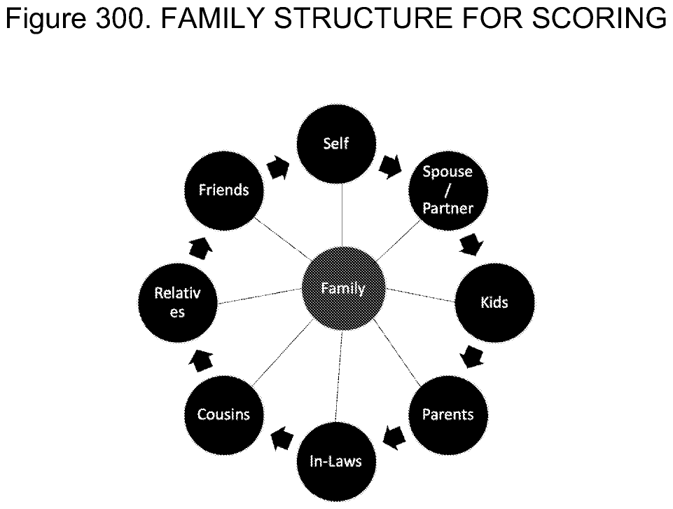

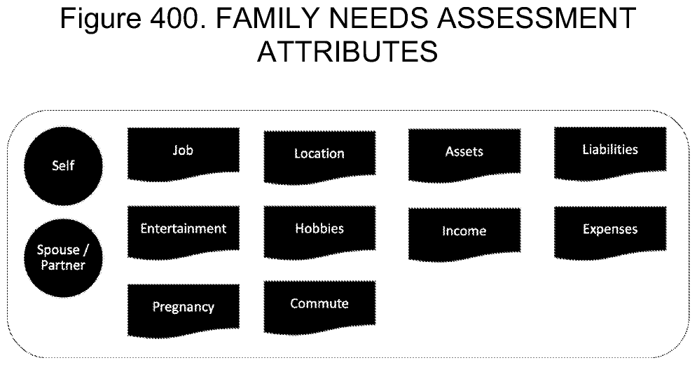

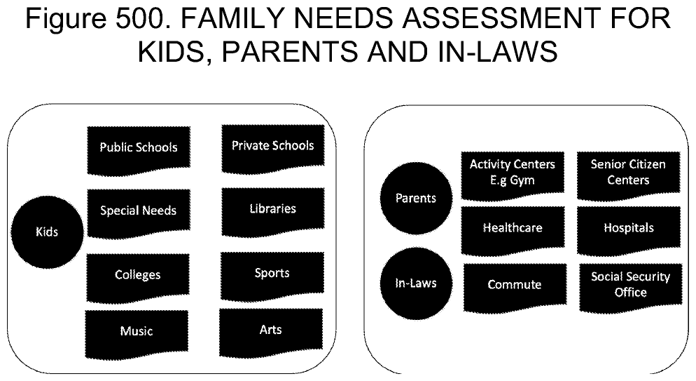

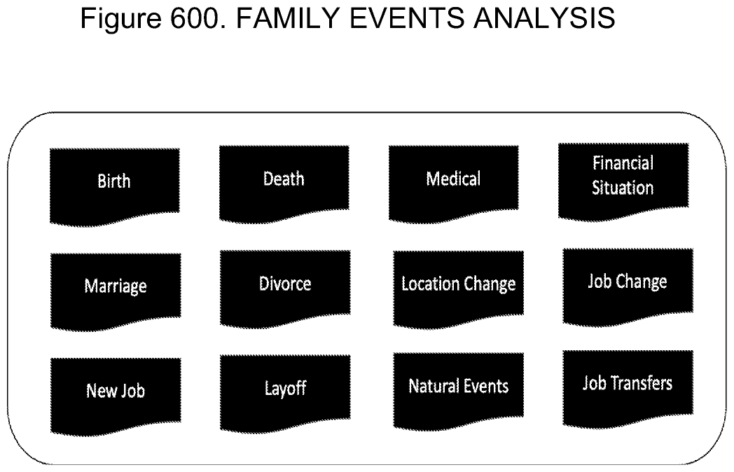

Please refer to drawings (FIG. 100 AI Based Family Scoring, FIG. 150 Family scoring engine architecture, FIG. 200 Family score model, FIG. 300 Family structure for scoring, FIG. 400 Family needs assessment attributes, FIG. 500 Family needs assessment for parents, kids and in-laws, FIG. 600 Family events analysis, FIG. 700 Detailed architecture) provided in the “Drawings” document submission.

### FIG. 100 AI Based Family Scoring

AI based family scoring engine provides a weighted score taking into account the analysis from different attributes to provide a suitability of a property based on family requirements. These include:
Family needs safety and crime rate analysis,
demographic and transportation analysis,
family event sentiment analysis,
geospatial and property image analysis,
primary residence property analysis, property sales and listing data,
financial need analysis
special needs and health care analysis

Multiple AI models are used to calculate the score. Collaborative filtering technique is used to derive similarity for data based analysis like Family needs, crime rate analysis etc to come out with an individual score. A Convolution Neural Network (CNN) is used for image and attribute recognition. A Hybrid approach which combines both these techniques is used to calculate the final score which determines the suitability of a property for a family.

### 101 Family Needs Analysis

Family needs analysis considers the needs of individual family members. Family members include self, spouse, partner, kids parents, in-laws, cousins, relatives and friends. Multiple and different attributes of each of these family members would be considered to comprehensively determine a family needs analysis score. A family with special needs requirements will have completely different criteria to evaluate a property compared with the family which needs elder care. This score will be used to evaluate suitability of different properties to the needs.

### 102 Safety and Crime Rate Analysis

The family wants to know the safety and crime rate in neighborhoods to make sure that they make the right decision when buying a property. The analysis takes into account safety features like nearness to the police station, fire station and crime rating in the neighborhood. The crime rates is based on multiple publicly available data like sex offenders list, City Police Department crime reports, Federal And State crime databases. The analysis would be used to determine suitability of a particular neighborhood where the property is located.

### 103 Demograhpic and Transportation Analysis

Each family has unique requirements around demographics and transportation. Senior citizens may want to live near other seniors or closer to a place of worship like Church. Families may want to look at sports facilities closer to the property and depending on their field of interest. Some of them may be interest in having their kids' schools or colleges closer to their interested property. Some families depending on their nature of interest would prefer properties closer to parks or recreational facilities like clubs or gym. Also is important is the distance to their job location, nature of transportation that is available. All these demographic and transportation needs are captured and analyzed.

### 104 Family Event Sentiment Analysis

Sentiment analysis is performed based on family events. Data is gathered from inputs provided by the family and publicly available information from social media applications like Facebook, Twitter and websites. For example a recent retiree looking for a property might be looking at downsizing, a family which is expecting a birth of a child will be interested in a kid friendly neighborhood. A sentiment can be positive, negative or neutral. These sentiments are analyzed along with the events to ensure that these inputs are considered for a family score.

### 105 Geo-Spatial and Property Image Analysis

An inside and outside image recognition end analysis at the property is done using Convolution Neural Network (CNN). The attributes of the property is culled out to alignment with the needs of the family. For example, the system would recognize a bathroom from a given list of images and cull out say a double vanity or a tub in the bathroom and store it as an attribute. These attributes are stored and assessed against the needs of the families looking for a property.

### 106 Primary Residence Property Analysis

This module will consider attributes for primary residence and calculate the primary residence score for primary residence. The score will include parameters like mortgage considerations applicable to primary residences.

### 107 Property Sales and Listings Analysis

Property sales and listings analysis will provide information about current available houses and the sales trend. This analysis will be oriented towards family needs and the fitment of the property based on available data related to sales of properties based on family criteria.

### 108 Financial Needs Analysis

Financial needs analysis encompasses various attributes such as availability of a preferred mortgage lender, terms of landing and preference of the family. Family scoring engine will consider these attributes derived from the financial needs' analysis.

### 109 Special Needs and Healthcare Analysis

Family may need special care for some of the family members, There may be also requirements pertaining to the healthcare situations of the family members. The family score will consider these parameters and then analysis will provide a weighted score,

### 110 Family Needs UI

A task based mobile and web user interface which captures the details of the family including their members, their needs and assessment attributes

### 111 Learning Centers

Data on learning centers including daycare, pre K facilities and enrichment programs would be captured.

### 112 Healthcare Facilities

Health care facilities including the nature of the facility, nearby hospitals, clinics, urgent care, pediatric facilities, assisted needs facilities, special needs and other facilities along with the location and address would be captured .

113 Special-Needs facilities

Family may have special needs kids or members that may require proximity to facilities such as healthcare centers etc. The purpose of this entity is to see the feasibility of the property as related to the family's special needs.

### 114 Citizen Safety

The embodiment considers various criteria for cities and safety such as crime rate, accident data in the neighborhood and location of the police stations/fire stations from the home. The family scoring engine will use information provided by government sources to compute various parameters for citizen safety information and add to the family scoring engine.

### 115 Mortgage Lending:

Family may be comfortable with a certain mortgage lender. The mortgage lending parameter will determine availability of such lender near the home or locality. Also availability of preferred mortgage lenders and option to choose from government programs for first-time buyers will be included in this criteria.

Availability of shopping malls theaters and other avenues of entertainment are considered as a parameter that will be added to family score. Availability of these entertainment centers will also be determined by the interest and hobbies of the family.

### 116 Entertainment

Availability of shopping malls theaters and other avenues of entertainment are considered as a parameter that will be added to family score. Availability of these entertainment centers will also be determined by the interest and hobbies of the family members.

### 117 Property Sales Trends Data

Property sales trends depend on many factors such as inventory, economic conditions and interest environment. The property sales trends are collected from various data sources that are used by the AI and machine learning analysis before including them into the family score.

### 118 Property Sales Data

This parameter will be collected based on the government property sales data from the county records and will be used to determine the fair value for the house. It will also be used to show the property prices nearby neighboring dwellers.

### 119 MLS Data

MLD data will be retrieved from the MLS listings. The data will be used to determine to refer an agent for the family. Family expectations will be used as a parameter to find most favorable agent and the availability of such an agent will be included as one of the parameters in family score.

### 120 Listing Websites

Currently available houses in the market place as advertised by listing websites. We will use the listing data from websites from MLS and the other property sales sites such as Zillow.

### 121 Maps

Maps information will be important to understand the proximity of various points of interest for the family. Geospatial information for these points of interests will be collected from the maps.

### 122 Property Images

Property images will be used to determine the suitability of the location of the house, property facilities such as clubhouse tennis courts etc.

### 123 Area Crime Rate

Area crime rate data will be collected and used in the family score to ascertain the security expectations of the family.

### 124 Property Broker Sales

We will collect the property broker data and match with expectations from the family so that they can find a preferred broker for they are buying needs.

### 125 Cost of Living

Cost of living data will be used as an input to the family score. This data will be collected from government/public sources based on price index etc.

### 126 Flood Zone and Flooding

Flood and flooding zone on information is important for the family before they make a decision on the property. This data will be collected from government sources and included in the calculation of family score.

### 127 Property Insurance Claim Records

Insurance claim records of the properties in the neighborhood which can have an impact on the price and provide an assessment of the risks will be captured.

### 128 Parks and Recreation

Data on Parks and Recreation including location, address, and facilities available would be captured.

### 129 State, City and Property Taxes

Data on state taxes, County city and property taxes is collected from different publicly available websites like a County site or State website. Previously available property tax data for properties is also collected.

### 130 Social Media Apps And Websites

Publicly available data from social media apps like Facebook, Twitter, next door, Instagram, LinkedIn and other websites.

### 131 Transportation

Data on the means of transportation that is available from different places within the neighborhood. This includes data Walkability of a particular area, access to train stations nearby, buses and other public transportation in the neighborhood.

### 132 Places of Worship

List of places of worship with the details including religion, sects, activities, address, geo spatial information and what it is famous for.

### 133 City Attributes

These are the attributes of the city including the facilities available, the demographics of the city, feedback from the residents of the city from apps like Nextdoor.

### 134 State Demographics

Demographics data of the state including available job data key industries, fastest growing sectors, areas of opportunities. This would be particularly relevant for families which are moving across different states.

### 135 Sports Facilities

This is the data on the sports facilities available in in neighborhood. These Includes public and private facilities like swimming pools, golf, clubs etc. As an example, a family which is interested in say racquetball would be keen on looking at properties near clubs which provide those facilities.

### 136 School/Colleges

Public, private, charter, magnet schools and college data along with it's rank, rating, address, test scores and demographic data. This data is secured from sites like greatschools.org, schooldigger.com, schooldata.com etc.

### 137 Senior Citizen Living Area Data

Senior citizen living area data is the demographics on senior citizens living in that city our neighborhood.

### FIG. 200 Family Score—End User View

The calculation of sample family score by the AI based family scoring engine. in this example the most preferred property is property IV. properties III and V are also close. For family 3 there is a significant scoring difference between property IV and all the other properties. So their stakes to acquire property IV are high if they prefer this neighborhood.

### FIG. 300 Family Structure for Scoring

Typical family structure considered for scoring. The needs of self, spouse or partner, kids, parents, in Laws, cousins, relatives and friends are considered. The weightages would be dependent on those key drivers impacting a family. For example a family might be keen on moving closer to an aged parent and that need might override on the other needs. So the weightages are determined on a family to family basis.

### FIG. 400 Family Needs Assessment Attributes

Attributes which are critical for self and spouse or partner are captured here. These include details of the job including its location, Hobbies that they want to pursue, entertainment nearby, commute facilities available and their financial status.

### FIG. 500 Family Needs Assessment For Kids, Parents and In-Laws

Needs and attributes which are critical for Kids, parents and in-laws Are captured here. While they vary from family to family some of the critical ones for Kids needs include good public schools, private schools, special needs, libraries, sports, colleges, music and arts. similarly for parents and in-laws some of the key needs would be around access to health care, activity centers, senior citizen centers etc

### FIG. 600 Family Events Analysis

Key Family events provide a leading indicator to future property purchases. key events like birth of a child, divorce, retirement, change in Financial situation etc are analyzed to provide the suitability.

### FIG. 150 Family Scoring Engine Architecture

### 151 Family Needs User Interface

A task based mobile and web user interface which captures the details of the family including their members, their needs and assessment attributes. It could also include virtual reality based interfaces and personas.

### 152 Family Scoring AI Engine

AI based family scoring engine provides a weighted score taking into account the analysis from different attributes to provide a suitability of a property based on family requirements. These include:
Family needs for safety and crime rate engine,
demographic and transportation engine,
family event sentiment engine,
geospatial and property image engine,
primary residence property engine, property sales and listing engine,
financial need engine
special needs and health care engine

Multiple AI models are used to calculate the score. Collaborative filtering technique is used to derive similarity for data based analysis like Family needs, crime rate analysis etc to come out with an individual score. A Convolution Neural Network (CNN) is used for image and attribute recognition. A Hybrid approach which combines both these techniques is used to calculate the final score which determines the suitability of a property for a family.

### 153 Family Needs Analysis Engine, Prioritization Engine

Data from defined family requirements or attributes and various sources is captured. This data is processed based on the priorities provided by the family leveraging AI. The processed data will generate a family needs score which will feed into Family Scoring AI Engine.

### 154 NLP Based Family Event Sentiment Analysis Engine

Sentiment analysis is performed based on family events. Data is gathered from inputs provided by the family and publicly available information from social media applications like Facebook, Twitter, Next door and other websites. The processed data will generate a Sentiment analysis score which will feed into Family Scoring AI Engine.

### 155 Primary Residence Property Analysis Engine

Data from defined property attributes and various sources is captured. This data is processed based on the priorities provided by the family leveraging AI. The processed data will generate a property score which will feed into Family Scoring AI Engine.

### 156 Geo-Spatial Data Analysis Engine

This Engine collects the data related to transportation to schools, place of work, office, healthcare facilities, places of worship and provides a geo spatial score for the property based on the family needs. The processed data will generate a geo spatial score which will feed into Family Scoring AI Engine.

### 157 Property Image Recognizition Engine

An inside and outside image recognition and analysis at the property is done using Convolution Neural Network (CNN). The attributes of the property is culled out to align with the needs of the family. For example, the system would recognize a bathroom from a given list of images and cull out say a double vanity or a tub in the bathroom and store it as an attribute. These attributes are stored and assessed against the needs of the families looking for a property. The processed data will generate an image affinity score which will feed into Family Scoring AI Engine.

### 158 Structured, Semi Structured and Unstructured Data

Data gathered from multiple databases, websites, apps and other sources such as social media. This data would be in multiple formats [Structured, Semi-Structured or Unstructured].

### FIG. 700 FAMILY SCORING ENGINE FOR RESIDENTIAL PROPERTY

AI based family scoring engine which provides a weighted score taking into account the analysis from different attributes to provide a suitability of a property based on family requirements.

### 703 Family Attirbutes

Attribute data of the family which includes composition of the family and attributes related to various types of family members such as self, spouse or partner, kids, parents, in-laws, cousins, relatives and friends.

### 704 Family Needs Data

Needs data of the family which includes the property requirements like bedrooms, bathrooms, schooling requirements etc as expressed by the family or someone acting on behalf of the family.

### 705 Special Needs

Data of special needs schools, voluntary organizations, medical facilities and government funded agencies.

### 707 School Rating

Public, private, charter, magnet schools and college data along with its rank, rating, address, test scores and demographics. This data is secured from sites like greatschools.org, schooldigger.com, schooldata.com etc.

### 708 Family Profile

Data about the financial and social profile of the family.

### 709 Demographics

State, County, City and neighborhood demographic data is captured and stored in the databased.

### 710 Sports Faciliites Data

Data on the sports facilities available. These Includes public and private facilities like swimming pools, golf, clubs etc.

### 712 NLP Corpus

Natural Language processing Corpus data for analyzing different sentiments and learn from the patterns. The corpus data keeps updated using AI.

### 713 Family Socio Collaboration Data

Social data available through subscriptions and general availability will be processed to create the database.

### 715 MLS Listing

MLS listing databased subscribed through various MLS listing channels.

### 716 City, Property Tax Data

Tax Data from the County, City and State is used to create the database

### 717 Crime Data

Data about police station, fire station and crime ratings in different neighborhood. The crime rates data is collected from multiple publicly available databases like sex offenders list, City Police Department crime reports, Federal and State crime databases.

### 718 Sales Data

Property sales data available with counties will be obtained from the county database.

### 719 Prop Sales Trends

Property sales trends will be obtained from commercially available data sources such as Corelogic.

### 720 Demographic Data

Data about the State, County, City and neighborhood demographics.

### 722 Family Walk Score

Walk score database will store the walk score information for the property obtained through existing data sources such as Walkscore.com.

### 723 Worship Places

Database of places of worship including religion, sects, activities, address, geo spatial information and what it is famous for.

### 724 Flooding Data

Database of flood zone, areas prone to flood from the available sources. This database will also other natural calamities such as earthquake, storms, seismic activity, tornadoes etc.

### 724 Hospital

Database consisting of healthcare facilities including the nature of the facility, nearby hospitals, clinics, urgent care, pediatric facilities, assisted needs facilities, special needs and other facilities along with the location and address.

### 726 Outside Property Images

Repository of the Images of the property taken from drone or other means outside the property.

### 727 Inside Property Images

Repository of the images taken inside the property

### 728 3D Image

3 Dimensional image database of the property.

### 729 Videos, Virtual Realty

Database consisting of Videos of the property including virtual realty data.

The following is claimed:

1. Family Scoring AI Engine: An Artificial intelligence and machine learning based scoring model which takes into account overall family requirements to determine the suitability of a property

2. Geo Spatial Data Analysis Engine: A deep learning-based method to perform a geo spatial analysis in-order to determine the proximity to the points of needs based on family requirements

3. Automated Property Image Attribute Analysis Engine: Image based property recognition model based on Convolution Neural Network (CNN) and Deep Learning to determine the attributes

4. Family Needs Analysis AI Engine and Prioritization Engine: An Artificial intelligence and machine learning based engine which provides a family needs score based on the priorities of the family

5. Primary Residence Property Analysis Engine: An Artificial Intelligence based engine which takes into account multiple attributes [features] of the property to calculate a primary residence property score

6. Family sentiment analysis which analyzes the plurality of events like loss of job, death, birth, retirement, marriage from social media and impact on the house buying preferences
